(19) United States
(12) Patent Application Publication
(10) Pub. No.: US 2007/0101919 A1
(43) Pub. Date: May 10, 2007

(54) Steering wheel and methods for steering a ship

(76) Inventor: William N. Keene, South Dartmouth, MA (US)

Correspondence Address: David J. Rikkers;Brown Rudnick Berlack Israels, LLP, One Financial Center, Boston, MA, 02111, US

(21) Appl. No.: 11/272,121

(22) Filed: Nov. 10, 2005

(51) Int. Cl. G05D 1/02; B63H 25/04; B63H 25/10

(52) U.S. Cl. 114/144 R

(57) ABSTRACT

An apparatus and method are provided for steering a ship. The use of a non-circular wheel enables an operator, such as a captain of a ship, to see over the wheel and have increased clearance to pass by the wheel, by the use of a reduced radius along at least a portion of an outer perimeter of the wheel. By maintaining a large radius along at least a portion of the wheel, the operator is still able to apply large amounts of torque to the steering mechanism as needed to steer the ship.

### BACKGROUND

Many ships have long been steered by the use of a wheel mounted to a steering pedestal. Typically, the wheel is round and may have handles extending radially outward. In most installations, one or more rudders are coupled to the wheel, such that the rudder deflection angle is controlled by the rotational position of the wheel. Because of the forces applied to rudders in some ships, a large amount of torque may be needed to change, or even maintain, a desired rudder deflection angle to steer the ship on the desired course. By the use of a large radius wheel, a captain can apply additional torque to steer the ship.

Difficulties have been encountered with the use of large diameter wheels in that they can obstruct a path that would allow a captain or passenger to walk past the wheel. For example, the steering pedestal and wheel are often located toward the stern of a boat, which is often narrower than the midsection of the boat. Because the boat may be somewhat narrow in the location where the wheel is located, the sides of the boat, or adjacent seating may be located close to the wheel, making passage between a side of the boat or seating and the wheel difficult. One solution to this problem has been the use of folding wheels, but folding wheels have introduced other problems, including a loss of strength of the wheel structure by the insertion of the hinges, the need to unlock and relock the hinges and the hinges forming an undesirable discontinuity in the perimeter of the wheel where the two separable parts of the wheel meet. Another undesirable aspect of some large diameter wheel installations is the partial obstruction of a forward view of the captain, due to one or more parts of the wheel extending upward to be located at eye level of the captain. In addition to obstruction of forward view, the wheel can obstruct the ability of the captain to reach the gauges or other items on the steering pedestal, necessitating the captain to reach through the wheel. When reaching through the wheel, the captain is prevented from rotating the wheel in accessing the gauges, accessories or controls on the steering pedestal.

### SUMMARY

Various embodiments of the present invention address a need in the art for the use of a wheel to steer a ship to enable the application of substantial torque required for steering, while avoiding many of the difficulties traditionally inherent in large diameter wheels.

In one embodiment of the invention, a steering apparatus for a ship is providing having a non-circular wheel and a steering pedestal configured to be mounted to the ship. The non-circular wheel is rotatably mounted to the steering pedestal. An outer perimeter of the wheel includes a first portion having a first minimum radius and a second portion having a second minimum radius. The first minimum radius is smaller than the second minimum radius, such that an operator could see over the first portion at least when the first portion is upward.

In another embodiment of the invention, a steering apparatus for a ship also includes a steering pedestal configured to be mounted to the ship. In this embodiment, a wheel mounted to the steering pedestal has an outer perimeter forming an oval.

In a further embodiment of the invention, a method for maneuvering a ship includes providing a steering pedestal on the ship and providing a non-circular wheel rotatably mounted to the steering pedestal, such that an operator could see over the wheel.

### BRIEF DESCRIPTION OF THE DRAWINGS

The invention will be apparent from the description herein and the accompanying drawings, in which like reference characters refer to the same parts throughout the different views.

FIG. 1 is a perspective view of a steering apparatus for a ship according to an implementation of an embodiment of the invention;

FIG. 2 is a view of a wheel according to an embodiment of the invention;

FIG. 3 is a view of the wheel of FIG. 2 in an inverted position;

FIG. 4 is a view of a wheel according to an embodiment of the invention;

FIG. 5 is a view of a wheel having an oval shape according to an embodiment of the invention; and

FIG. 6 is an illustration of a method according to an illustrative embodiment of the invention.

### DETAILED DESCRIPTION

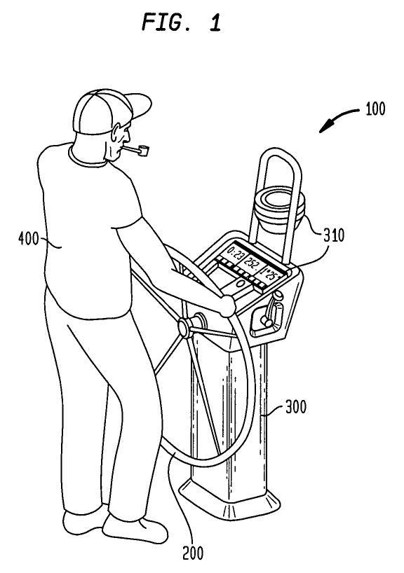

FIG. 1 illustrates a steering apparatus 100 for a ship according to an illustrative embodiment of the present invention. The steering apparatus 100 includes a non-circular wheel 200 and a steering pedestal 300. Optionally, one or more gauges 310 may be mounted on the steering pedestal 300. A wide variety of other accessories and/or controls may be mounted on the steering pedestal 300, as known in the art.

The steering pedestal 300 is mounted to the ship according to various methods known in the art. The non-circular wheel 200 is coupled to a rudder or other device mounted to the ship to control a direction of the ship in relation to the rotational position of the non-circular wheel 200. An operator 400, such as a captain, may stand, or optionally sit, near the non-circular wheel 200.

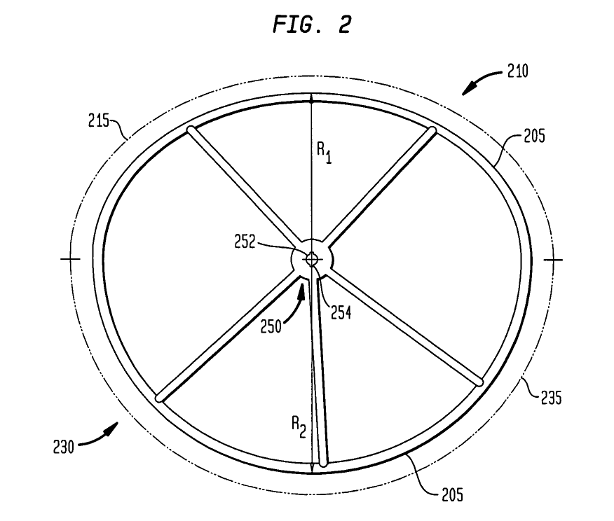

As illustrated by way of example in FIG. 2, an illustrative embodiment of a non-circular wheel 200A is shown having a first portion 210 and a second portion 230. The first portion 210 has a minimum radius R₁ smaller than a minimum radius R₂ of the second portion 230. According to the illustrative embodiment of FIG. 2, the first portion 210 extends over an arc 215 of approximately 180° and the second portion 230 extends over an arc 235 of approximately 180°. In FIG. 2, a minimum radius R₁ of the first portion 210 is approximately 60% of the minimum radius R₂ of the second portion 230.

According to the illustrative embodiment of FIG. 2, the first portion 210 has a radius that continually increases in both directions away from the minimum radius R₁ as the outer perimeter 205 of the non-circular wheel 200A approaches the second portion 230. The second portion 230 of the illustrative embodiment of FIG. 2 has a constant radius, e.g. the radius remains equal to the minimum radius R₂.

In other illustrative embodiments, the first radius R₁ is no more than 80% of the second minimum radius R₂. In another example, the first radius R₁ is no more than 60% of the second minimum radius R₂. In a further example, the second minimum radius R₂ is equal to a radius of the second portion 230 over an arc of at least 150°.

A wide variety of minimum radius ratios are within the scope of the invention. In an illustrative implementation of this embodiment of the invention, the minimum radius R₁ of the first portion is 12 inches and the minimum radius R₂ of the second portion 230 is 20 inches. In another illustrative implementation, the minimum radius R₁ is approximately 14½ inches and the minimum radius R₂ is 20 inches. In a further illustrative implementation, the minimum radius R₁ is approximately 11 inches and the minimum radius R₂ is 22 inches. In this implementation, the minimum radius R₂ is a constant radius over a 200° arc. In some implementations, the wheel forms a D-shape.

Embodiments of the present invention are directed toward wheels having a second portion radius up to approximately 30 inches. Hubs of such wheels are mounted at approximately three feet or higher off the floor surface near the steering pedestal. Therefore, by use of a non-circular wheel according to the present invention, at least when the portion of the wheel having the reduced radius is upward, a typical operator can see over the wheel and/or reach over the wheel to access the gauges, instruments or controls located on the steering pedestal.

The non-circular wheel may be formed of a wide variety of materials known in the art for forming ship steering wheels. Examples can include, but are not limited to, stainless steel, teak, bronze, aluminum, plastic and cast iron.

The hub 250 of the non-circular wheel 200A is provided with a mounting hole 252 within which another rotational component of the steering mechanism may be mounted. A key way 254 is also provided for use with a key to secure the non-circular wheel 200A to the rotational component of the steering mechanism (not shown). Optionally, the wheel may be dished, e.g. the hub 250 may be offset from the outer perimeter.

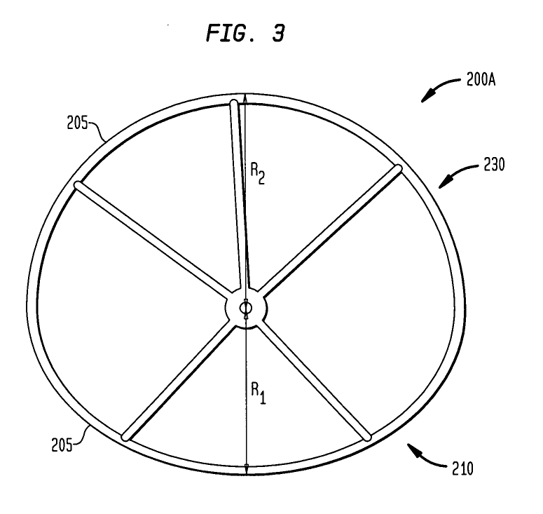

According to an embodiment of the invention, the second portion 230 may be located in an upward position relative to the first portion 210 when the ship is steered in a straight ahead direction. FIG. 3 illustrates the non-circular wheel 200A of FIG. 2 in an inverted position, having the second portion 230 located in an upward position relative to the first portion 210. Optionally, two key ways 254 may be provided to enable the wheel to be mounted with the first portion 210 upward or downward.

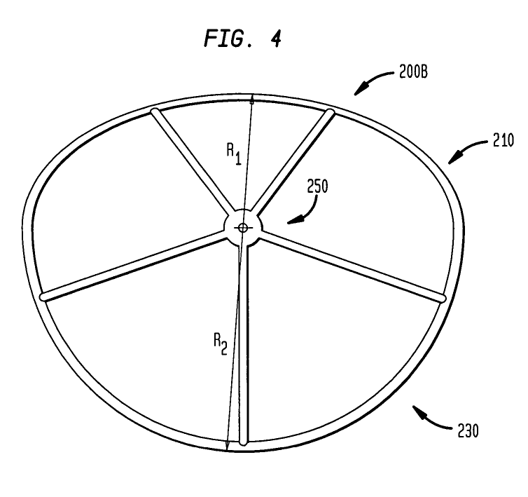

FIG. 4 illustrates a further embodiment of the invention providing a non-circular wheel 200B having a minimum radius R₁ of a first portion 210 equal to approximately 72% of a minimum radius R₂ of a second portion 230. The non-circular wheel 200B provides a further example of a non-circular wheel according to an embodiment of the invention.

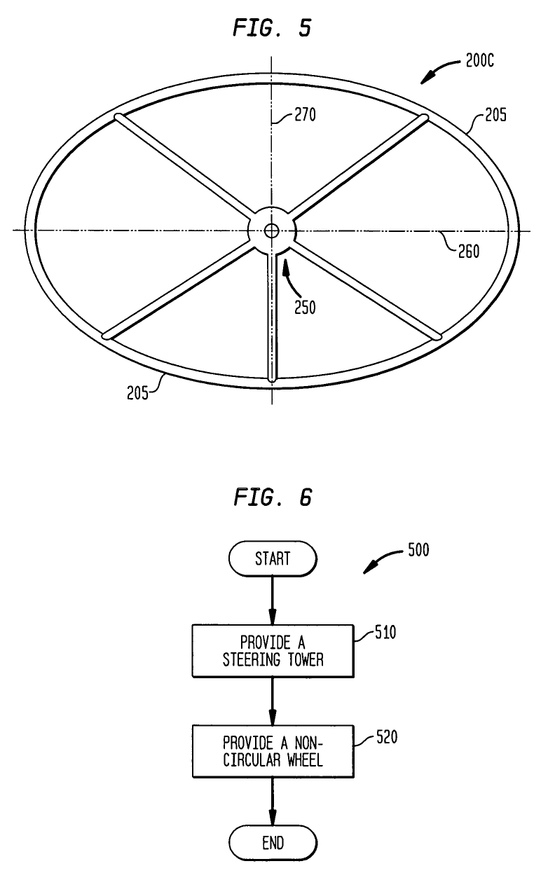

With reference to FIG. 5, a non-circular wheel 200C in the shape of an oval is illustrated according to an illustrated embodiment of the invention. The oval shape of the non-circular wheel 200C has a major axis 260 and a minor axis 270. While a wide variety of dimensions are within the scope of the invention, in one example, implementation of the invention, the minor axis is approximately 60% of the major axis.

A further embodiment of the invention is described in relation to FIG. 6. A method 500 for maneuvering a ship includes the acts of providing a steering pedestal 510 and providing a non-circular wheel 520. The act of providing a non-circular wheel 520 includes providing the wheel rotatably mounted to the steering pedestal, such than an operator can see over the wheel.

Optionally, in providing the non-circular wheel, an outer perimeter of the wheel can include a first portion having a first minimum radius and a second portion having a second minimum radius. In an example implementation, the first minimum radius is no more than 80% of the second minimum radius and the second minimum radius is a constant radius of the second portion. Also optionally, the outer perimeter of the wheel may form an oval.

In operation, the non-circular wheel 200 of the present invention may be rotated to locate the first portion 210 to a side of the steering pedestal so as to provide increased clearance for the operator to pass by the wheel. In another example implementation of the invention, the gauge 310 mounted to the steering pedestal 300 is viewable by the operator 400 at least when the first portion 210 of the wheel 200 is upward. Optionally, The operator 400 may rest at least one forearm on the first portion 210. According to various example implementations if the invention, the first portion 210 may be located upward or downward when steering the ship straight ahead.

Also in operation, if the non-circular wheel 200 is in the shape of an oval, the major axis 260 of the oval may be positioned vertically to provide increased clearance for the operator 400 to pass by the wheel. In an example implementation invention, the major axis 260 is positioned horizontally when steering the ship straight ahead.

The illustrative embodiments, implementations and examples herein are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. The preferred embodiments are merely illustrative and should not be considered restrictive in any way.

1. A steering apparatus for a ship, comprising:
a steering pedestal configured to be mounted to the ship;
a non-circular wheel having a generally central hub rotatably mounted to the steering pedestal and an outer perimeter of the wheel comprising a first portion having a first minimum radius and a second portion having a second minimum radius, the first minimum radius being at least 50% of the second minimum radius such that an operator could see over the first portion at least when the first portion is upward; and
five spokes extending radially from the central hub to the outer perimeter to the wheel.

2. The apparatus of claim 1, wherein the first portion extends along an approximately 180 degree arc.

3. The apparatus of claim 1, wherein the second minimum radius is equal to a radius of the second portion over an arc of at least 150 degrees.

4. The apparatus of claim 3, wherein the first portion has a radius that continually increases in both directions away from the first minimum radius and approaching the second portion.

5. The apparatus of claim 3, wherein, the first minimum radius is no more than 80% of the second minimum radius.

6. The apparatus of claim 3, wherein the first minimum radius is no more than 60% of the second minimum radius.

7. The apparatus of claim 3, the first radius is approximately 60% of the second minimum radius.

8. The apparatus of claim 1, wherein the first minimum radius is no more than 80% of the second minimum radius, the second minimum radius being a constant radius of the second portion.

9. The apparatus of claim 1, wherein the non-circular wheel can be rotated to locate the first portion to a side of the steering pedestal to provide increased clearance for the operator to pass by the wheel.

10. The apparatus of claim 1, further comprising a gauge mounted to the steering pedestal, the gauge viewable by the operator at least when first portion of the wheel is upward.

11. The apparatus of claim 1, wherein an operator can rest at least one forearm on the first portion.

12. The apparatus of claim 1, wherein the first portion is upward when steering the ship straight ahead.

13. The apparatus of claim 1, wherein the first portion is downward when steering the ship straight ahead.

14. A steering apparatus for a ship, comprising:
a steering pedestal configured to be mounted to the ship; and
a wheel mounted to the steering pedestal and an outer perimeter of the wheel forming an oval.

15. The apparatus of claim 14, wherein the oval has a major axis and a minor axis, the minor axis approximately 60% of the major axis.

16. The apparatus of claim 14, wherein the wheel can be rotated to locate the major axis of the oval vertically to provide increased clearance for the operator to pass by the wheel.

17. The apparatus of claim 1, wherein a major axis of the oval is horizontal when steering the ship straight ahead.

18. A method for maneuvering a ship, comprising:
providing a steering pedestal on the ship; and
providing a non-circular wheel rotatably mounted to the steering pedestal, an outer perimeter of the wheel comprising a first portion having a first minimum radius and a second portion having a second minimum radius, the first minimum radius being at least 50% of the second minimum radius such that an operator could see over the first portion at least when the first portion is upward.

19. The method of claim 18, wherein the first minimum radius is no more than 80% of the second minimum radius, the second minimum radius being a constant radius of the second portion.

20. The method of claim 18, wherein, in the providing a non-circular wheel step, an outer perimeter of the wheel forms an oval.

21. A steering apparatus for a ship, comprising:
a steering pedestal configured to be mounted to the ship;
a non-circular wheel having a central hub rotatably mounted to the steering pedestal and an outer perimeter of the wheel comprising a first portion having a first minimum radius that extends an approximately 180 degree arc and a second portion having a second minimum radius, the first minimum radius being at least 50% of the second minimum radius such that the first portion is upward when steering the ship straight ahead and an operator could see over the first portion at least when the first portion is upward;
five spokes extending radially from the central hub to the outer perimeter to the wheel; and
a gauge mounted to the steering pedestal, the gauge viewable by the operator at least when first portion of the wheel is upward.
